(19) United States
(12) Patent Application Publication
(10) Pub. No.: US 2008/0095478 A1
(43) Pub. Date: Apr. 24, 2008

(54) HYDRO-BUSH BEARING WITH ACOUSTIC DECOUPLING

(75) Inventors: Frank MEYERINK, Lohne (DE); Claudia HOPING, Lohne (DE)

Correspondence Address: NORRIS, MCLAUGHLIN & MARCUS, 875 THIRD AVE, 18TH FLOOR, NEW YORK, NY, 10022, US

(73) Assignee: ZF FRIEDRICHSHAFEN AG, Friedrichshafen (DE)

(21) Appl. No.: 11/760,846

(22) Filed: Jun. 11, 2007

(30) Foreign Application Priority Data
Jul. 13, 2006 (DE) DE 102006032633.4

(51) Int. Cl. F16F 13/14; F16C 32/06

(52) U.S. Cl. 384/1

(57) ABSTRACT

An elastomer bush bearing with hydraulic damping, which is simultaneously configured for acoustic decoupling. The proposed hydro-bush bearing includes, in a conventional manner, a tubular metallic inner part (1) and an elastomer bearing body (2) which encompasses the inner part (1) and is connected with the inner part (1) by vulcanization. The corresponding rubber-metal part is formed of metal or plastic and adapted for insertion into an outer sleeve. At least two chambers (3, 4) adapted to receive a liquid damping means are formed in the bearing body (2) and connected by a damping channel (5) which is open in an unloaded state. An additional channel (6) is arranged between the chambers (3, 4), which in the unloaded state of the bearing is closed for the damping means by a sealing lip (7). The sealing lip is constructed so as to oscillate with an amplitude in excess of 0.025 mm at high-frequency loads. In addition, support elements (8, 9) are arranged on both sides of the sealing lip (7) which limit the oscillation amplitude of the sealing lip (7) for loads which cause displacement amplitudes of the bearing body of greater than 0.15 mm.

### BACKGROUND OF THE INVENTION

1. Field of the Invention

The invention relates to an elastomer bush bearing with hydraulic damping which is simultaneously configured for an acoustic decoupling, i.e., for decoupling high-frequency oscillations having small amplitudes.

2. Description of the Related Art

Elastomer bush bearings, which are used predominantly in the automobile industry for supporting chassis components, consist generally of a metallic, mostly substantially cylindrical or tubular inner part, an outer sleeve concentrically encompassing the inner part and an elastomer bearing body disposed between the inner part and the outer sleeve. The bearing body is generally adhesively connected at least with the inner part through vulcanization. Depending on the application, the bearings include also additional hydraulic damping, in particular for damping low-frequency oscillations having large amplitudes. To provide hydraulic damping, at least two working chambers adapted to receive a fluid damping means are formed in the elastomer bearings body and connected with each other by a channel. When a load is applied in the region of one of the chambers, the fluid damping means is displaced from the corresponding chamber and flows through the damping channel into the respective other chamber. The fluid damping means which flows back and forth between the chambers noticeably dampens of low-frequency, large-amplitude oscillations. This is, in one hand, caused by an extinction effect or mass damping and, on the other hand, by throttle or friction damping, wherein mass damping is produced by the force required for displacing the fluid damping means and friction damping is produced by the friction due to fluid flow along the channel walls. Depending on the configuration of the damping channel, either the mass damping component or the friction damping component is dominant. The chambers and the damping channel form a hydraulic damping system.

To protect bush bearings, which are also referred to as hydro-bushings, against overloading and damage caused by an excessively high pressure difference between the damping means chambers, it is known to provide between the chambers an additional, shorter overflow or bypass channel. An interlock is disposed in the overflow channel which opens the overflow channel only when a predefined pressure difference between the chambers is exceeded.

Such bearing is described, for example, in DE 40 20 713 C2. The outer sleeve of the bearing described in the aforementioned reference is encompassed by a radially deformable protective tube. Both the actual damping channel and an additional overflow channel are formed on the outside periphery of the outer sleeve, i.e., between the outer sleeve and the protective tube. While the damping channel continuously connects the working chambers formed in the bearing body for fluid conduction, the overflow or bypass channel is normally blocked by a throttle rail. When the predetermined pressure difference between the working chambers is exceeded, the protective tube is deformed in the region of the throttle rail, thereby opening the overflow channel and reducing the overpressure via this channel which is generally shorter than the damping channel.

DE 195 26 069 A1 describes a slightly different embodiment of a hydraulically damping bush bearing with an overflow channel. In this embodiment, the damping channel and the overflow channel are formed by suitably shaping the bearing body. The suitably shaped bearing body also forms a throttle element implemented as a bellow which closes the overflow channel. If the pressure difference between the damping means chambers becomes sufficiently large, this throttle element is pushed aside by the damping means, opening the overflow channel.

Other types of hydro-bushings are known which are similar to the embodiments described above with reference to FIG. 2. In these hydro-bushings, both the damping channel and the overflow channel are formed on the outer periphery of the bearing, whereby the overflow channel is closed by a sealing lip which is formed of the same material as the bearing body and protrudes radially from the outer periphery into the overflow channel. If the pressure difference between the chambers determined exceeds a rated pressure difference for the sealing lip, the sealing lip turns over and opens the overflow channel to equalize the pressure, thereby preventing destruction of the bearing.

As mentioned above, hydro-bushings mainly dampen low-frequency oscillations having a large amplitude. In particular, conventional hydro-bushings are unable to provide acoustic decoupling due to the small installation space existing in most applications. The bearing therefore transmits almost undamped the high-frequency oscillations of small amplitude, which are produced, for example, by tire noise resulting from contact between the tire and the road surface or by rumble noise. Although the design of the hydro-bushing advantageously provides a perceptible damping effect, it is ineffective in reducing those oscillations that are frequently in the audible frequency range.

It is therefore an object of the invention to provide a hydro-bushing capable of effectively damping low-frequency oscillations having a large amplitude by using the annihilation effect and/or throttle damping, while simultaneously providing acoustic decoupling.

### SUMMARY OF THE INVENTION

The object is solved by a hydro-bushing having the features of the independent claim. Advantageous embodiments and modifications of the invention are recited in the dependent claims.

The hydro-bush bearings proposed for solving the object of the invention is made in an essentially conventional manner from a tubular metallic inner part and an elastomer bearing body encompassing the inner part and connected with the inner part by vulcanization, wherein the so formed rubber-metal part are adapted for insertion in substantially cylindrical outer sleeve made of metal or plastic. At least two chambers adapted to receive a fluid damping means are formed in the bearing body, which in conjunction with at least one damping channel, which connects the chambers and is open for the fluid damping means, form a hydraulic damping system.

Moreover, an additional channel is arranged between the chambers, which in the unloaded state of the bearing is closed for the damping means by a sealing lip disposed on the external periphery of the bearing body between the bearing body and the outer sleeve receiving the rubber-metal part and the bearing body, respectively.

According to the invention, of the sealing lip is formed with respect to the material and the geometry so as to oscillate, when oscillation loads are introduced into the bearing from the radial direction which cause the bearing body to be springily displaced with an amplitude of 0.025 mm or more, commensurate with the volume of the damping means that is displaced by the spring displacement of the bearing body. According to the invention, is also limited by two support elements arranged on both sides of the sealing lip, which operate as oscillation amplitude limiters. The oscillation amplitude limiters are designed and positioned relative to the sealing lip so as to limit those oscillations of the sealing lip generated at the sealing lip by loads that cause spring displacements of the bearing body having an amplitude of more than 0.15 mm. With the sealing lip and the support elements limiting the oscillation amplitude of the sealing lip, a system with a bearing with a soft sealing lip is provided that decouples acoustic oscillations, meaning high-frequency oscillations having a small amplitude, which are then not transmitted, for example, to the vehicle chassis.

The requirement for a soft design of the sealing lip does not necessarily apply only to its material, but more generally to a soft characteristic with respect to the employed material and the geometric shape of the sealing lip. Accordingly, if the sealing lip protruding radially from the bearing body is made of a harder material, it must be made particularly thin in the peripheral direction of the bearing so as to permit oscillations. This may be the case, for example, if the sealing lip according to the preferred embodiment of the bearing of the invention is made of the same material as the bearing body, i.e., the material is a hard material, commensurate with the required high bearing stiffness. Based on the interdependence between the material of sealing lip and its geometry, it is basically not possible to provide definitive values for these parameters. The configuration of the sealing lip was therefore defined in the independent claim through its effect. Based on the inventive concept, those skilled in the relevant art will be able to the design the sealing lip so that it is capable of oscillating under load with a spring defection amplitude of >0.025 mm. It is therefore not an object of the invention to provide corresponding values. According to the invention, an entirely new functionality is assigned to the overflow channel and a bypass channel, which are otherwise known in the art. Whereas this channel is used in conventional bearings for overload protection, in the present invention, the additional channel and the correspondingly (soft) sealing lip in conjunction with the oscillation amplitude limiters arranged on both sides of the sealing lip provide acoustic decoupling. Whereas the sealing lip in hypo-bushings with overload protection is not intended to oscillate, but rather turn over instantaneously when the spring deflection of the bearing body exceeds a predefined limit amplitude, thereby opening the overflow channel for the damping means, the bush bearing according to the invention, at least in its a basic implementation, makes separate overload protection unnecessary.

According to the fundamental idea of the invention, the sealing lip does therefore not represent an “overload protection”, but rather enables small volumes of the damping means to flow back and forth through the additional channel, which is blocked in the unloaded state of the bearing, because the sealing lip oscillates at high-frequency loads with a small amplitude. In the context of the invention, this channel which is similar to the overflow channel employed in conventional bearings will be referred to hereinafter also as decoupling channel, considering its acoustic decoupling functionality produced in combination with the sealing lip and the oscillation amplitude limiters.

According to a preferred embodiment of the invention, for loads pertinent for acoustic decoupling, the oscillation amplitude limiters are spaced from the sealing lip so as to limit the oscillation amplitude of the sealing lip for those load amplitudes, or more particularly spring displacements of the bearing body, of greater than 0.1 mm. In the context of the description of the invention, the term load amplitude is to be understood as the corresponding amplitude of the spring deflection of the bearing for a particular load. As mentioned above, the bearing is designed for easy manufacturability so that the sealing lip is formed as part of the bearing body of the same material as the bearing body by a corresponding protrusion on the bearing body.

The oscillation amplitude limiters can be arranged and implemented in different ways. For example, they can be formed by elements that protrude from the inner wall of the outer sleeve radially into the interior of the bearing. However, such configuration may be regarded as less advantageous due to manufacturing difficulties as well as difficulties associated with the installation of the bearing in the outer sleeve. The oscillation amplitude limiters are therefore preferably formed by two radial protrusions formed on the outer periphery of the bearing body. According to a particularly preferred embodiment, the oscillation amplitude limiters are formed by two plastic elements disposed on the outer periphery of the bearing body and radially protruding from the bearing body.

Hydro-bush bearings are known where the damping channels or the overflow channel connecting the chambers are formed in a separate channel support element made of plastic and encompassing the bearing body in the region of the chambers. The bearing of the invention can also be implemented in this manner. Advantageously, the amplitude limiters in these embodiments may be implemented by suitable protrusions disposed on the outer periphery of the channel support element.

If it is nevertheless desired to list specific parameter values relating to the geometry of the sealing lip, then the ratio between the axial extent of the sealing lip and its extent in the radial direction should be >1 for bearings with a sealing lip that is made of the same material as the bearing body having a typical hardness.

Following the basic idea of the invention, according to a particularly advantageous embodiment of the bearing of the invention, the sealing lip is provided with an oscillation amplitude limiter, i.e., for acoustic decoupling, and performs the additional function of protecting the bearing from overloads known from conventional bearings. The sealing lip hereby is herein implemented of two differently formed regions in the radial direction. One of these regions is capable of oscillating, with its oscillation amplitude being limited for load amplitudes of >0.15 mm, as described above. The other region of the sealing lip is designed, preferably by giving it a different geometric shape, so as to turn over for radial loads, which would introduce spring defections with an amplitude of 0.3 mm or more in the bearing body, thereby opening the additional channel, or the decoupling channel, for the damping means.

Other objects and features of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS

FIG. 1 an isometric view of an exemplary embodiment of the hydro-bushing of the invention; and

FIG. 2 an isometric view of a conventional hydro-bushing with overflow channel.

### DETAILED DESCRIPTION OF THE PRESENTLY PREFERRED EMBODIMENTS

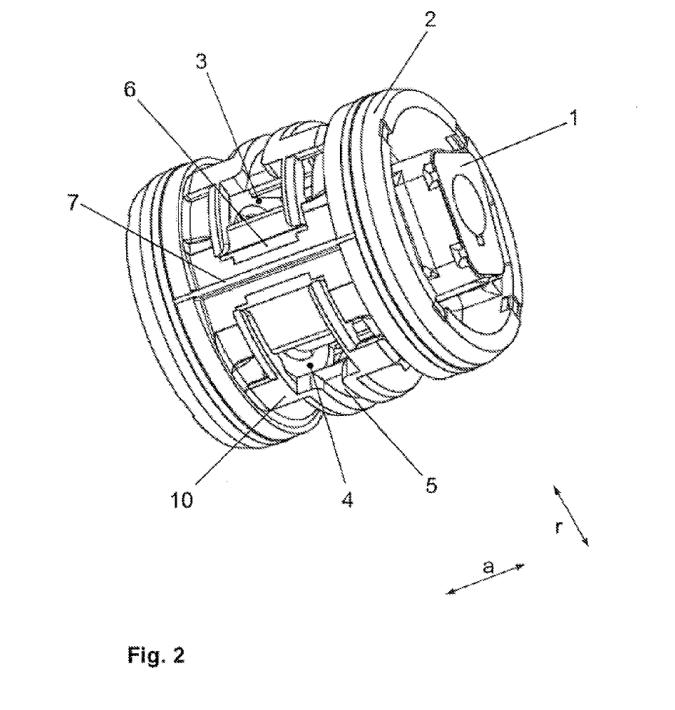

A conventional hydro-bushing illustrated in FIG. 2 will be discussed first. A hydro-bushing typically consists of a metallic inner part 1, an elastomer bearing body 2 encompassing the inner part 1 and preferably connected with the inner part 1 by vulcanization, and an outer sleeve receiving the aforementioned parts. The outer sleeve is not shown in FIG. 2. As evident from in FIG. 2, the elastomer bearing body 2 includes on its periphery two chambers 3, 4 adapted to receive damping means, which in the fully assembled bearing are bounded in the radial direction r by the outer sleeve (not shown). The chambers 3, 4 are connected by a relatively narrow and long channel 5 which extends along almost the entire periphery of the bearing. This channel 5 forms in conjunction with the chambers 3, 4 a hydraulic damping system. When the bearing is subjected to a load with a corresponding amplitude, the damping means introduced into the damping system flows back and forth between the chambers 3, 4 according to the frequency of these oscillations, thereby substantially extinguishing the introduced load amplitudes. If the oscillations impressed on the bearing have an amplitude greater than a limit value defined by the dimensions of the damping system, then the bearing may be destroyed by the large pressure differences between the chambers 3, 4. This may be prevented by providing in the bearing an additional channel 6 formed as overflow or bypass channel. This short channel 6 which connects the adjacent chambers disposed on the periphery is closed by a throttle element 7 in the inactive state of the bearing and under normal load. In the illustrated example, this throttle element is a sealing lip 7 arranged in the channel 6 and formed of the same elastomer material as the bearing body 2, whereas the damping channel 5 and the decoupling channel 6 are implemented in a separately formed channel support element made of plastic that is snapped onto the outer periphery of the bearing body 2. At high loads that produce a large pressure difference between the chambers 3, 4, this sealing lip 7 is opened by the damping means. The damping means can then flow directly via the wide overflow channel 6 along a short path from one chamber 3, 4 into the respective other chamber, so that the large pressure difference is quickly reduced, preventing destruction of the bearing. Corresponding bearings are typically designed so that the throttle element or the sealing lip 7 opens the overflow channel 6 only if the load amplitudes exceed 0.3 mm, and are potentially even in the range of millimeters. At smaller amplitude, in a so-called comfort zone, the sealing lip 7 must not open, so that the bearing can perform the distinct damping function desired from the arrangement of the hydraulic damping system. The overflow channel 6 is provided and opened above a threshold amplitude only for increasing the service life of the bearings.

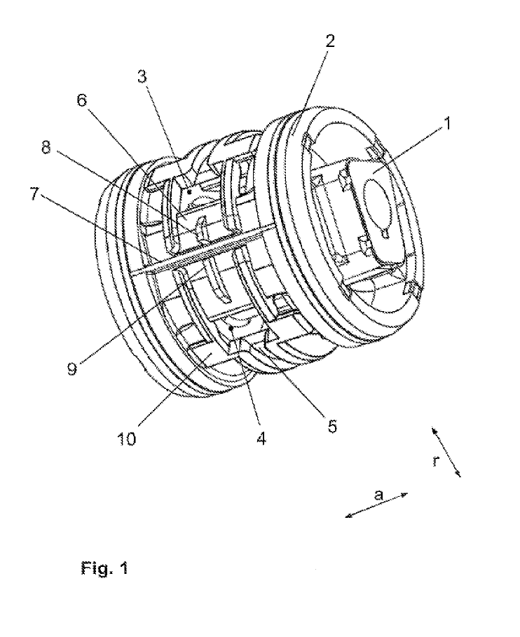

The situation with the bearing of the invention, which is illustrated in the form of an exemplary embodiment in FIG. 1, is different. This bearing should have, on one hand, a defined damping characteristic for low-frequency oscillations with a large amplitude and, on the other hand, should simultaneously provide acoustic decoupling. The first of the aforementioned two functions of this bearing is also provided by a conventional hydraulic damping system consisting of the two chambers 3, 4 and the damping channel 5 connecting the chambers 3, 4. This bearing also includes, in addition to the actual damping channel 5, an additional short channel 6 disposed between the chambers 3, 4, which is closed by a sealing lip 7. However, the channel 6 has a different function than that in conventional bearings which are exclusively designed to provide a distinct damping function.

To this end, the rubber lip 7 which projects into the decoupling channel 6 is constructed to be softer than in a bearing of the type shown in FIG. 2. Because the rubber lip 7 of the bearing of the invention is also formed of the same elastomer material as the actual bearing body 2, whose hardness or stiffness is defined directly by the application of the bearing, the soft design of the rubber lip 7 necessary for the functionality according to the invention is determined to a lesser degree, or at least not exclusively, by the material itself, but rather by the dimensions of the rubber lip or sealing lip 7. The dimensions are selected so that the fractions of the damping means displaced from the chambers 3, 4 are capable of displacing the sealing lip 7 at amplitudes of induced oscillations between 0.025 mm and 0.1 mm. However, the sealing lip 7 is not moved in a way so as to open the additional channel 6 instantaneously. instead, the sealing lip 7 oscillates back and forth with a small amplitude, thereby allowing very small quantities of the damping means to pass through the decoupling channel 6 in both directions. In this way, acoustic decoupling is achieved.

According to the invention, the oscillation amplitude of the sealing lip 7 is limited by support elements 8, 9 arranged on the periphery of the bearing body 2 on both sides of the sealing lip 7. Therefore, only the portion of the oscillation amplitude in the predefined range between 0.025 mm and 0.1 mm and the volume fraction of the damping means displaced by this portion of the oscillation amplitudes have an effect on the sealing lip 7 at greater loads, i.e., for greater oscillation amplitudes, whereas amplitudes exceeding this range are damped in a conventional manner by the damping channel 5. However, in the illustrated exemplary embodiment, the sealing lip 7 never completely opens the decoupling channel 6.

The aforedescribed basic embodiment of the bearing of the invention therefore intentionally eliminates a separate overload protection. However, the bearing may also be designed with the aforedescribed configuration of the sealing lip 7 and arrangement of the support elements 8, 9 which limit the oscillation amplitude, so that one part of the sealing lip 7 provides acoustic decoupling, whereas another part of the rubber lip or sealing lip 7, whose travel is not limited by the support elements 8, 9, can instantaneously turn over under an overload, thereby enabling larger quantities of the damping means to flow through the short channel 6 from one chamber into the other.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

What is claimed is:

1. A hydro-bush bearing comprising
a tubular metallic inner part (1),
an elastomer bearing body (2) encompassing the inner part (1) and connected with the inner part (1) by vulcanization, which are provided for insertion into a substantially cylindrical outer sleeve,
wherein at least two chambers (3, 4) adapted to receive a fluid damping means are formed in the bearing body (2), which in conjunction with at least one damping channel (5), which connects the chambers and is open for the fluid damping means, form a hydraulic damping system, and
wherein in addition to the damping channel (5) at least one additional channel (6) is arranged between the chambers (3, 4), which in the unloaded state of the bearing is closed for the damping means by a sealing lip (7) which is disposed on the external periphery of the bearing body (2) between the bearing body (2) and the outer sleeve receiving the bearing body (2), and
wherein the material and the geometry of the sealing lip (7) are selected so that the sealing lip (7), when oscillation loads are introduced into the bearing from the radial direction (r) which cause the bearing body (2) to be springily displaced with an amplitude of 0.025 mm or more, oscillates commensurate with the fluid damping means volume that is displaced by the spring displacement of the bearing body (2), and wherein support elements (8, 9) are arranged on both sides of the sealing lip (7), which form oscillation amplitude limiters that limit the oscillation amplitude of the sealing lip (7) at least for those oscillations generated at the sealing lip (7) by loads that cause spring displacements of the bearing body having an amplitude of more than 0.15 mm.

2. The hydro-bush bearing according to claim 1, wherein the oscillation amplitude limiters (8, 9) are spaced from the sealing lip (7) so as to limit the oscillation amplitude of the sealing lip (7) for those loads on the bearing that cause spring displacements of the bearing body (2) having an amplitude of greater than 0.1 mm.

3. The hydro-bush according to claim 1, wherein the sealing lip (7) is formed as part of the bearing body (2) by a corresponding protrusion on the bearing body (2).

4. The hydro-bush according to claim 1, wherein the oscillation amplitude limiters (8, 9) are formed by two protrusions formed on the outer periphery of the bearing body on both sides of the sealing lip.

5. The hydro-bush according to claim 1, wherein the oscillation amplitude limiters (8, 9) are formed by plastic elements disposed on the outer periphery of the bearing body and radially protruding from the bearing body.

6. The hydro-bush according to claim 5, wherein the at least one damping channel (5) and the additional channel (6), into which the sealing lip (7) protrudes, are implemented in a separately formed channel support element (10) made of plastic which encompasses the bearing body (2) at the axial height of the damping means chambers (3, 4), and wherein the oscillation amplitude limiters (8, 9) are formed as part of the channel support element (10) by protrusions formed on the channel support element (10) on both sides of the sealing lip (7).
